(19) United States
(12) Patent Application Publication
(10) Pub. No.: US 2002/0150316 A1
(43) Pub. Date: Oct. 17, 2002

(54) Bearing assembly

(76) Inventor: Ian C. D. Care, Derby (GB)

Correspondence Address: MANELLI DENISON & SELTER, 2000 M STREET NW SUITE 700, WASHINGTON, DC, 20036-3307, US

(21) Appl. No.: 10/107,156

(22) Filed: Mar. 28, 2002

(30) Foreign Application Priority Data
Apr. 17, 2001 (GB) 0109327.7

(51) Int. Cl. F16C 33/76

(52) U.S. Cl. 384/477

(57) ABSTRACT

A bearing assembly (10) comprising relatively rotatable structures (12, 14) and a bearing (16), the bearing (16) is configured to work in operative association with the relatively rotatable structures (12, 14) to enable relative rotation therebetween, the relatively rotatable structures (12, 14) co-operate to define a bearing chamber (34), wherein the bearing chamber (34) is further defined by means to vary the volume (20) of the bearing chamber (34) between a first volume and a second volume, the second volume being greater than the first volume.

This invention relates to an arrangement for a bearing assembly and in particular, although not exclusively, a pressurised bearing assembly for a gas turbine engine.

Lubricating oil is retained within a bearing assembly by operating the bearing assembly with a lower pressure inside the bearing assembly than outside, thereby ensuring that any leakage will ingress the assembly. However, under certain operational conditions of a gas turbine engine it is possible for a reversal of pressures to occur and which may lead to oil escaping the bearing assembly. This is clearly not desirable as the escaping oil may then contaminate other engine and aircraft systems.

It is therefore an object of the present invention to provide apparatus to obviate the above problem.

According to the present invention there is provided a bearing assembly comprising relatively rotatable structures and a bearing, the bearing is configured to work in operative association with the relatively rotatable structures to enable relative rotation therebetween, the relatively rotatable structures co-operate to define a bearing chamber, wherein the bearing chamber is further defined by means to vary the volume of the bearing chamber between a first volume and a second volume, the second volume being greater than the first volume.

Preferably, during a first operation of the bearing assembly the bearing chamber operates with an internal pressure P1 which is lower than an external pressure P2 and the bearing chamber occupies the first volume, and during a transient operation of the rotating assembly P2 drops below P1 and the means to vary the volume changes the volume of the bearing chamber to the second volume, thereby substantially equilibrating the internal and external pressures P1 and P2.

Preferably, the relatively rotatable structures comprise a static structure and a rotatable structure.

Preferably, the means to vary the volume of the bearing chamber comprises a substantially annular flexible membrane. Alternatively, the means to vary the volume of the bearing chamber comprises a circumferentially segmented flexible membrane.

Preferably, the means to vary the volume of the bearing chamber is associated with the static structure.

Preferably, the transient phase occurs between the first operation and a second operation.

Preferably, the rotatable and static structures define a seal, which seal defines part of the bearing assembly and the bearing is enclosed by the bearing assembly.

Preferably, the rotatable and static structures define two seals, each seal defines part of the bearing assembly and the bearing is enclosed by the bearing assembly. Alternatively, there are two bearings provided in the bearing assembly.

Preferably, the bearing assembly comprises oil, the bearings being lubricated by the oil.

Preferably, a gas turbine engine comprises a bearing assembly as herein claimed and the rotatable structure is a shaft configured for rotation relative to the static structure, which is static architecture of the engine.

The present invention will now be described, by way of example, with reference to the accompanying drawings in which:

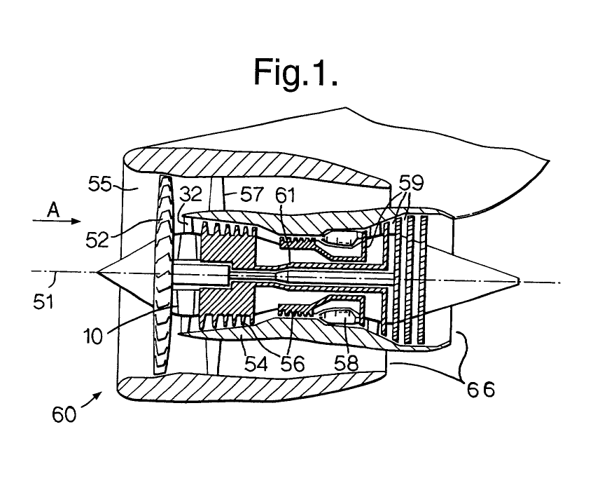

FIG. 1 is a schematic section of a ducted fan gas turbine engine incorporating an embodiment of the present invention.

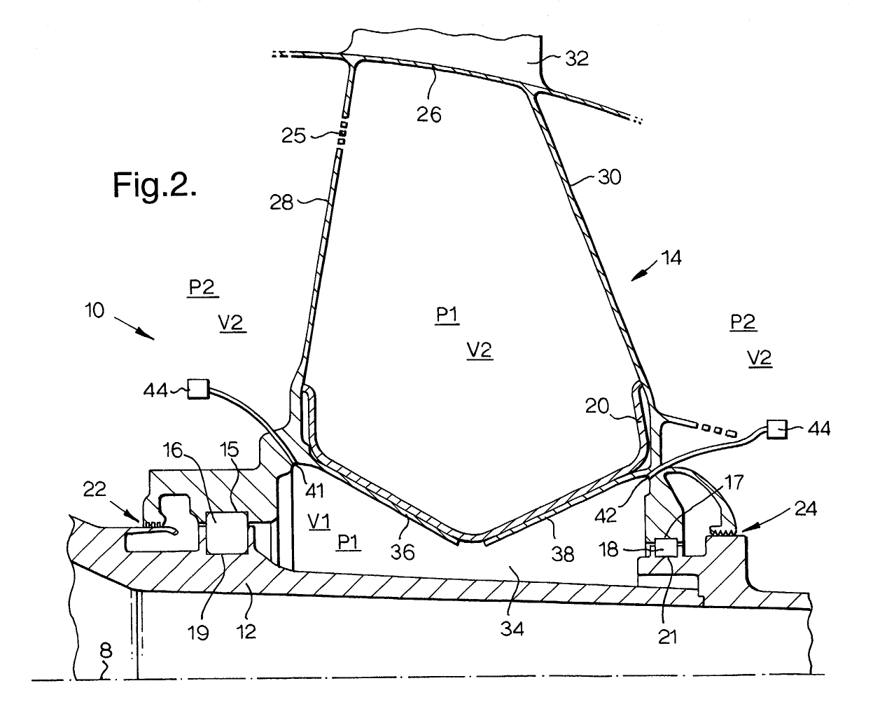

FIG. 2 is an axial section through a bearing assembly of the gas turbine engine, shown in FIG. 1, during a first operating condition showing the present invention in a first position.

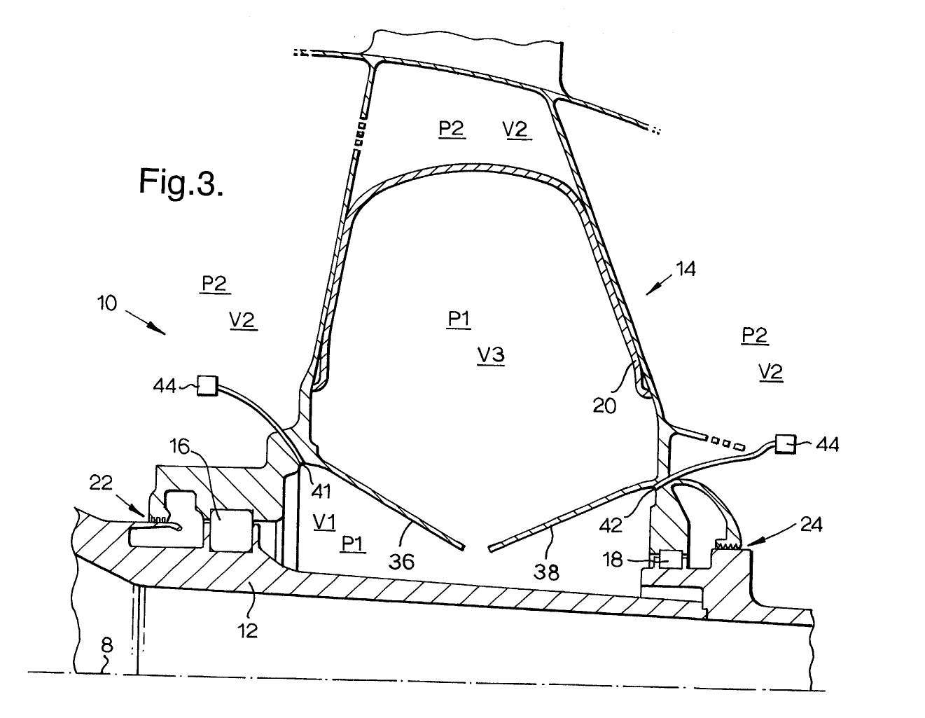

FIG. 3 is an axial section through a bearing assembly of the gas turbine engine, shown in FIG. 1, during a transient phase between the first operating condition and a second operating condition showing the present invention in a second position.

With reference to FIG. 1 a ducted fan gas turbine engine 60 comprises, in axial flow series an air intake 55, a propulsive fan 52, a core engine 54 and an exhaust nozzle assembly 66 all disposed about a central engine axis 51. The core engine 54 comprises, in axial flow series, a series of compressors 56, a combustor 58, and a series of turbines 59. The direction of airflow through the engine 60 in operation is shown by arrow A. Air is drawn in through the air intake 55 and is compressed and accelerated by the fan 52. The air from the fan 52 is split between a core engine flow and a bypass flow. The core engine flow passes through an annular array of stator vanes 32 and enters core engine 54, flows through the core engine compressors 56 where it is further compressed, and into the combustor 58 where it is mixed with fuel which is supplied to, and burnt within the combustor 58. Combustion of the fuel mixed with the compressed air from the compressors 56 generates a high energy and velocity gas stream which exits the combustor 58 and flows downstream through the turbines 59. As the high energy gas stream flows through the turbines 59 it rotates turbine rotors extracting energy from the gas stream which is used to drive the fan 52 and compressors 56 via engine shafts 61 which drivingly connect the turbine 59 rotors with the compressors 56 and fan 52. Having flowed through the turbines 59 the high energy gas stream from the combustor 58 still has a significant amount of energy and velocity and it is exhausted, as a core exhaust stream, through the engine exhaust nozzle assembly 66 to provide propulsive thrust. The remainder of the air from, and accelerated by, the fan 52 flows within a bypass duct 57 around the core engine 54. This bypass air flow, which has been accelerated by the fan 52, flows to the exhaust nozzle assembly 66 where it is exhausted, as a bypass exhaust stream to provide further, and in fact the majority of, the useful propulsive thrust. The annular array of stator vanes 32 is supported by a bearing assembly 10 configured in accordance with the present invention.

With reference to FIG. 2, the bearing assembly 10 comprises relatively rotating structures 12, 14. In this embodiment of the present invention the relatively rotating structures 12, 14 comprise a rotatable shaft 12 and static architecture of the engine 60. The rotatable shaft 12 and static structure 14 co-operate to define a bearing chamber 34 which is also further and partly defined by a means to vary the volume 20 of the bearing chamber 34. The Figure shows the means to vary the volume 20 of the bearing chamber 34 in a first position and occupying a first volume.

The rotatable shaft 12 has a rotational axis 8 which is common with the engine axis 51, and which connects a turbine to a compressor (see FIG. 1) of the gas turbine engine 60. The static member 14, which is relatively stationary architecture of the engine 60, comprises generally radially extending annular walls 28, 30 and a further annular wall 26 interconnecting the radially outer ends of the radially extending annular walls 28, 30. A stator vane 32 is one of an annular array of similar stator vanes that extend radially outward from the annular wall 26 and operate in a conventional manner. An orifice 25 is provided in the annular wall 28 for fluid communication therethrough. A further orifice may also be provided in the annular wall 30.

The radially inner ends of the radially extending annular walls 28, 30 define seal elements 22, 24 respectively, and radially outer races 15, 17 for co-operative association with roller bearing elements 16, 18. The shaft 12 defines complimentary radially inner races 19, 21. Other types of bearing may be used as are commonly known in the art and which are intended to be within the scope of the present invention. The bearings 16, 18 are most commonly lubricated and cooled with oil although other fluids such as coolants or grease may be present. Alternatively the bearings 16, 18 may be cooled by a gas or a powder. The seal elements 22, 24 and bearings 16, 18 work in operative association with the shaft 12 and the static structure 14 to enable relative rotation therebetween. The seal elements 22, 24 are designed to minimise and control the amount of fluid leakage therethrough.

In a further embodiment of the present invention the relatively rotating structures 12, 14 may further comprise a second shaft (not shown). The second shaft may be co-axial with the shaft 12 and may rotate either the same direction or counter rotate. In this further embodiment, the shaft 12 comprises bearing 16 and co-operating portion for seal 22 and the second shaft comprises bearing 18 and co-operating portion for seal 24.

The means to vary the volume 20 of the bearing chamber 34 comprises a flexible membrane 20, which is located axially between the radially extending annular walls 28, 30 and radially inward of annular wall 26. In the embodiment described herein the flexible membrane 20 is in sheet form and generally annular, its axially forward and rearward edges secured to the radially extending annular walls 28, 30 respectively. However, without departing from the scope of the present invention, and in a further embodiment not shown, the flexible membrane 20 may be circumferentially segmented so as to co-operate in operative association with commonplace gas turbine engine 60 static architecture 14.

The generally annular bearing chamber 34 is thereby defined by the space radially inward of the flexible member 20, radially outward of the shaft 12 and between the radially inward portions of the annular walls 28, 30 and, as shown in FIG. 2, having a first volume V1. The bearings 16, 18 are therefore located within the bearing chamber 34 which is further defined by the seal elements 22, 24.

During a first operation, in this embodiment of the present invention a normal operating condition of the gas turbine engine 60, there exists in the bearing chamber 34 an internal pressure P1, and external to the bearing chamber 34 an external pressure P2. The orifice(s) 25 is provided to allow the external pressure P2 to exist between the generally radially extending annular walls 28, 30 and radially outward of the bearing chamber 34.

During the first operation of the gas turbine engine 60, which includes a constant engine speed, for instance at aircraft cruise, the pressure P1 is less than pressure P2 and therefore the flexible membrane 20 is forced into its first position which is generally the radially innermost contour it can occupy. When the flexible membrane 20 is in the first position the volume of the bearing chamber 34 is V1. It is preferable for the flexible membrane 20 not to take up substantially the whole of the bearing chamber 34 and therefore flanges 36 and 38 are provided, which generally axially extend from the radially extending annular walls 28, 30 to limit the extent of radially inward movement of the flexible membrane 20 during the first engine operating condition. The flanges 36, 38 may be part or completely annular. The flanges 36, 38 also extend radially inwardly to prevent bearing chamber 34 oil centrifuging radially outward onto the flexible member 20. Although the static structure 14 is stationary the rotating shaft 12 causes air turbulence within the chamber 34 which picks up the oil and centrifuges the oil radially outwardly. The centrifuged oil collects at the base of the flanges 36, 38, where it is scavenged through passages 41 and 42 by a scavenge pump 44.

It is desirable to provide the bearing chamber 34 with the scavenge pump 44, which is designed and operated to maintain the balance of pressures within the bearing chamber 34 and remove the oil, from the base of the flanges 36, 38, thereby maintaining a general flow of air through the seal elements 22, 24 which contains the lubricating oil therein.

With reference to FIG. 3, which is an axial section through the bearing assembly 10 of a gas turbine engine 60 during a transient phase between the first operating condition and a second operating condition showing the flexible membrane 20 in a second position occupying a second volume. The same reference numerals used in FIG. 2 are used in FIG. 3 to denote the same components.

The transient phase is generally where pressure P2 drops quickly and, but for the present invention, significantly below pressure P1 within the bearing chamber 34. This transient engine condition occurs, for instance, when the engine is throttled back or its rotational speed reduced in some other way. It is not always possible for the scavenge pump 44 to reduce pressure P1 sufficiently, and quickly enough, from inside the bearing chamber 34 to prevent oil (and air) from exiting through the seal elements 22, 24. In the event of the air and oil mixture escaping from the bearing chamber 34, the oil may then contaminate the surrounding air systems including the aircraft cabin air supply.

The present invention seeks to overcome this transient problem by the provision of the flexible membrane 20 which is capable of changing the volume of the bearing chamber 34 in accordance with the change in relative pressures P1 and P2 and thereby maintain a suitable pressure difference to prevent any substantial oil leakage from the bearing chamber 34. It should be noted that it is usual for the scavenge pump 44 to be in continuous operation whereby it is constantly removing oil and air from the bearing chamber 34. It is during the transient phase, occurring very soon after a change from the first engine condition to the second engine condition that the present invention operates.

During the transient phase, when P2 is just less than P1 the operation of the flexible membrane 20 begins and as can be seen in FIG. 3 the flexible membrane 20 moves to the second position where the volume of the bearing chamber 34 has increased significantly from the first volume V1 to the second volume (V1 plus V3). The flexible membrane 20 only achieves a maximum deflection, as shown in FIG. 3, under worst case conditions. This change in volume substantially equilibrates the internal and external pressures P1 and P2 and thereby there is little or no pressure difference between the internal and external pressures P1 and P2. Consequently, there is insufficient pressure difference to expel oil out of the bearing chamber 34 and therefore there is no contamination of the engine 60 and aircraft air systems.

It should be appreciated that the flexible membrane 20 may in fact occupy any position between its first and second positions in order to increase the volume of the bearing chamber 34.

After a short time the scavenge pump 44 is able to remove sufficient fluid from the bearing chamber 34 so that the flexible membrane 20 is then forced back to its first position.

The flexible membrane 20 may be fabricated from a flexible material such as a plastic or elastic material such as rubber. Alternatively, the means to vary the volume 20 of the bearing chamber 34 may comprise rigid elements which are hinged so as to accommodate the necessary movement. Furthermore, the flexible member 20 may be segmented, cascaded, cellular or in the form of a concertina or generally piston like. It should be appreciated that each embodiment of the flexible membrane 20 is capable of occupying the first position and the second position and operating in general accordance with the teachings of the description herein.

Whilst endeavouring in the foregoing specification to draw attention to those features of the invention believed to be of particular importance it should be understood that the Applicant claims protection in respect of any patentable feature or combination of features hereinbefore referred to and/or shown in the drawings whether or not particular emphasis has been placed thereon.

I claim

1. A bearing assembly comprising relatively rotatable structures and a bearing, the bearing is configured to work in operative association with the relatively rotatable structures to enable relative rotation therebetween, the relatively rotatable structures co-operate to define a bearing chamber, wherein the bearing chamber is further defined by means to vary the volume of the bearing chamber between a first volume and a second volume, the second volume being greater than the first volume.

2. A bearing assembly as claimed in claim 1 wherein, in use, during a first operation of the bearing assembly the bearing chamber operates with an internal pressure P1 which is lower than an external pressure P2 and the bearing chamber occupies the first volume, and during a transient operation of the rotating assembly P2 drops below P1 and the means to vary the volume changes the volume of the bearing chamber to the second volume, thereby substantially equilibrating the internal and external pressures P1 and P2.

3. A bearing assembly as claimed in claim 1 wherein the relatively rotatable structures comprise a static structure and a rotatable structure.

4. A bearing assembly as claimed in claim 1 wherein the means to vary the volume of the bearing chamber comprises a substantially annular flexible membrane.

5. A bearing assembly as claimed in claim 1 wherein the means to vary the volume of the bearing chamber comprises a circumferentially segmented flexible membrane.

6. A bearing assembly as claimed in claim 4 wherein the means to vary the volume of the bearing chamber is associated with the static structure.

7. A bearing assembly as claimed in claim 5 wherein the means to vary the volume of the bearing chamber is associated with the static structure.

8. A bearing assembly as claimed in claim 2 wherein the transient phase occurs between the first operation and a second operation.

9. A bearing assembly as claimed in claim 1 wherein the rotatable and static structures define a seal, which seal defines part of the bearing assembly and the bearing is enclosed by the bearing assembly.

10. A bearing assembly as claimed in claim 1 wherein the rotatable and static structures define two seals, each seal defines part of the bearing assembly and the bearing is enclosed by the bearing assembly.

11. A bearing assembly as claimed in claim 1 wherein there are two bearings provided in the bearing assembly.

12. A bearing assembly as claimed in claim 1 wherein the bearing assembly comprises oil, the bearings being lubricated by the oil.

13. A gas turbine engine wherein the engine comprises a bearing assembly as claimed in claim 1.

14. A gas turbine engine as claimed in claim 13 wherein the rotatable structure is a shaft configured for rotation relative to the static structure, which is static architecture of the engine.
